(19) United States
(12) Patent Application Publication
(10) Pub. No.: US 2011/0271936 A1
(43) Pub. Date: Nov. 10, 2011

(54) AIR INTAKE POWERED ENGINE BACKPRESSURE REDUCING SYSTEM

(75) Inventors: James Reyenga, Long Beach, CA (US); William Joseph Smith, Gardena, CA (US); Jeffrey Allen Lotterman, Brno (CZ)

(73) Assignee: Honeywell International Inc.

(21) Appl. No.: 12/773,345

(22) Filed: May 4, 2010

(51) Int. Cl. F02M 15/00; F01N 3/10; F01N 5/02; F01N 1/00; F01D 17/00; F02M 35/10

(52) U.S. Cl. 123/542; 415/145; 123/184.56; 60/320; 60/323; 60/299

(57) ABSTRACT

An engine system includes an internal combustion engine and an air intake assembly configured to supply a flow of air to one or more cylinders of the internal combustion engine. The air intake assembly includes an air supply conduit with a turbine therein, a bypass conduit configured to bypass the turbine, and a fresh air valve configured to selectively direct the flow of air to one or both of the air supply conduit and the bypass conduit. An exhaust conduit is configured to receive a flow of exhaust gas from the internal combustion engine and direct the flow of exhaust gas away from the internal combustion engine. A compressor in the exhaust conduit, which may be coupled to the turbine by a shaft, is configured to rotate and thereby reduce backpressure in the exhaust conduit during idle and partial throttle conditions.

### BACKGROUND OF THE INVENTION

1. Field of the Invention

The present application relates to air intake assemblies comprising turbines which power compressors in exhausts and associated systems and methods.

2. Description of Related Art

The throttling of intake air is a known way of controlling the output of internal combustion engines. Specifically, throttling of intake air is used in spark ignition engines, although some diesel engines may also employ throttling of intake air. Known embodiments of internal combustion engines use throttle bodies to throttle the intake air. Through throttling the flow of air, the engine load may be controlled by achieving the desired density of air in the intake manifold. However, the throttle body reduces intake manifold air density by an isenthalpic expansion process whereby there is no change in enthalpy, and thus no work extracted. However, the throttling of air may cause a loss in efficiency during throttling. Specifically, throttle bodies in some embodiments use butterfly valves to throttle the flow of intake air. While butterfly valves are known for their simplicity and reliability, they provide the throttling function by constricting the air intake path to a smaller area, which creates losses. In particular, the engine must produce additional output in order to overcome pumping losses from pumping the air from the lower intake manifold pressure to a higher exhaust system backpressure.

Thus, prior art solutions have been developed which seek to control the flow of intake air while recovering some of the energy lost in the throttling process. However, the prior art solutions may not fully take advantage of efficiency gains, and may further suffer from additional complexity.

Accordingly, it may be desirable that an improved engine system be provided which is relatively less complex and which may provide gains in engine efficiency.

### BRIEF SUMMARY OF THE INVENTION

The present disclosure in one aspect describes an engine system comprising an internal combustion engine comprising one or more cylinders. The engine system includes an air intake assembly configured to supply a flow of air to the one or more cylinders of the internal combustion engine. The intake assembly comprises an air supply conduit with a turbine therein, a bypass conduit configured to bypass the turbine, and a fresh air valve configured to selectively direct the flow of air to one or both of the air supply conduit and the bypass conduit. Further, the engine system includes an exhaust conduit configured to receive a flow of exhaust gas from the one or more cylinders of the internal combustion engine and direct the flow of exhaust gas away from the internal combustion engine, and a compressor in the exhaust conduit configured to reduce backpressure in the exhaust conduit.

In some embodiments the system may further comprise an intake manifold configured to receive the flow of air from the intake assembly and distribute the flow of air to two or more of the cylinders. In some embodiments the fresh air valve is the only valve for controlling the flow of air into the intake manifold. Additionally, an exhaust manifold may be configured to receive the flow of exhaust gas from one or more of the cylinders of the internal combustion engine and direct the flow of exhaust gas to the exhaust conduit. Also, a heat exchanger may be configured to transfer heat from the flow of exhaust gas in the exhaust conduit to the flow of air in the air supply conduit.

In some embodiments the system may further comprise a catalytic converter upstream of the heat exchanger. Further, an after-cooler may be configured to cool the flow of air before the flow of air enters the internal combustion engine. The after-cooler may be configured to cool the flow of air after the flow of air is expanded by the turbine. The system may further comprise an exhaust bypass conduit and an exhaust valve, wherein the exhaust valve is configured to selectively direct the flow of exhaust gas from the one or more cylinders of the internal combustion engine to the exhaust conduit and the exhaust bypass conduit. In some embodiments the exhaust valve is in the exhaust bypass conduit. Additionally, the exhaust bypass conduit may be in fluid communication with the exhaust conduit downstream of the compressor. Further, the fresh air valve may be in the bypass conduit. Also, the system may further comprise a variable nozzle.

Embodiments additionally include a method of controlling a flow of air to an internal combustion engine. The method comprises selectively directing the flow of air to the internal combustion engine with a fresh air valve through an air supply conduit with a turbine therein, and a bypass conduit configured to bypass the turbine, expanding the flow of air through the turbine to generate shaft power using vacuum created by the internal combustion engine, and driving a compressor connected to an exhaust side of the internal combustion engine using the shaft power from the turbine to thereby receive and compress a flow of exhaust gas, wherein the compressor operates to reduce backpressure on the exhaust side of the internal combustion engine.

In some embodiments the method further comprises heating the flow of air in the air supply conduit by directing the flow of air through a heat exchanger configured to transfer heat from the flow of exhaust gas to the flow of air. The method may additionally include cooling the flow of air before the flow of air enters the internal combustion engine by directing the flow of air through an after-cooler. In some embodiments the flow of air is cooled by the after-cooler after the flow of air is expanded by the turbine. Also, the method may further comprise directing the flow of exhaust gas through an exhaust bypass conduit to thereby bypass the turbine when the flow of air is directed by the fresh air valve through the bypass conduit. Further, the method may include adjusting a nozzle of the turbine to control the flow of air into the internal combustion engine.

Embodiments additionally include an air intake assembly configured to supply a flow of air to the one or more cylinders of an internal combustion engine. The intake assembly comprises an air supply conduit with a turbine therein, a bypass conduit configured to bypass the air supply conduit, and a fresh air valve configured to selectively direct the flow of air to one or both of the air supply conduit and the bypass conduit.

### BRIEF DESCRIPTION OF THE SEVERAL VIEWS OF THE DRAWING(S)

Having thus described the embodiments in general terms, reference will now be made to the accompanying drawings, which are not necessarily drawn to scale, and wherein:

FIG. 1 illustrates a schematic view of an engine system configured to reduce exhaust backpressure according to an example embodiment;

FIG. 2 illustrates a flow path through the engine system of FIG. 1 when the engine system is operating in partial-throttle conditions; and

FIG. 3 illustrates a flow path through the engine system of FIG. 1 when the engine system is operating in full-throttle conditions.

### DETAILED DESCRIPTION OF THE DRAWINGS

Apparatuses and methods for reducing exhaust backpressure for an engine now will be described more fully hereinafter with reference to the accompanying drawings in which some but not all embodiments are shown. Indeed, the present development may be embodied in many different forms and should not be construed as limited to the embodiments set forth herein; rather, these embodiments are provided so that this disclosure will satisfy applicable legal requirements. Like numbers refer to like elements throughout.

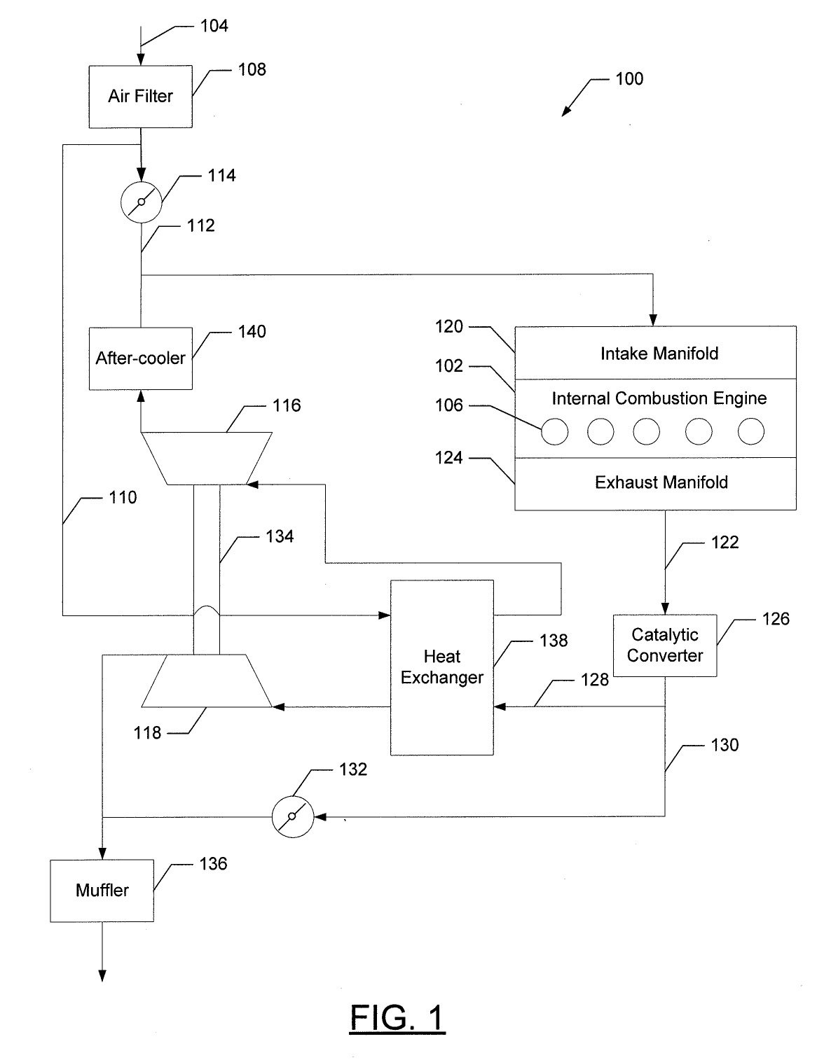

As schematically illustrated in the FIG. 1, an engine system 100 for reducing exhaust backpressure on an engine is provided. The engine system 100 comprises an internal combustion engine 102. A flow of air 104 is provided to the internal combustion engine 102 during operation. The flow of air 104 is supplied to one or more cylinders 106 of the internal combustion engine 102 by an air intake assembly.

The air intake assembly may comprise an air filter 108 which is configured to filter out dust, dirt, and other impurities from the flow of air 104. After traveling through the air filter 108, the flow of air 104 may travel through an air supply conduit 110 and/or a bypass conduit 112. A fresh air valve 114 is configured to selectively direct the flow of air 104 through one or both of the air supply conduit 110 and the bypass conduit 112. The fresh air valve 114 may be positioned in the bypass conduit 112 in some embodiments. Further, the fresh air valve 114 may in some embodiments comprise a butterfly valve. Thus, in some embodiments the fresh air valve 114 may comprise a traditional throttle body as is known within the automotive arts.

When the fresh air valve 114 directs the flow of air 104 through the air supply conduit 110, the flow of air is expanded by a turbine 116 in the air supply conduit. As will be explained in detail below, this may cause a compressor 118 to rotate. After the flow of air 104 travels through the turbine 116 it enters the internal combustion engine 102. In some embodiments the flow of air 104 may first be directed through an intake manifold 120, which receives the flow of air from the intake assembly and distributes the flow of air to two or more of the cylinders 106 of the internal combustion engine 102.

As mentioned above, the flow of air 104 may alternatively be directed by the fresh air valve 114 through the bypass conduit 112. When the flow of air 104 is directed through the bypass conduit 112, it bypasses the air supply conduit 110 and the turbine 116 and travels to the internal combustion engine 102. The flow of air 104 through the bypass conduit 112 may be directed through the intake manifold 120 in some embodiments prior to entering the cylinders 106 of the internal combustion engine 102.

After the flow of air 104 is mixed with fuel, for example, diesel fuel or gasoline, the mixture of fuel and air is combusted in the cylinders 106 of the internal combustion engine 102. The combustion process produces a flow of exhaust gas 122 which exits the internal combustion engine 102. In some embodiments the flow of exhaust gas 122 may be received and combined into fewer streams than the number of cylinders 106 by an exhaust manifold 124. After the flow of exhaust gas 122 exits the internal combustion engine 102, it may travel through a catalytic converter 126. The catalytic converter 126 may be used to reduce the toxicity of the flow of exhaust gas 122 from the internal combustion engine 102, for example, to meet emissions requirements.

The flow of exhaust gas 122 may also be directed by the exhaust manifold 124 from the cylinders 106 to one or both of an exhaust conduit 128 and an exhaust bypass conduit 130 and away from the internal combustion engine 102. Flow of the exhaust gas 122 through the exhaust conduit 128 and/or the exhaust bypass conduit 130 may be controlled by an exhaust valve 132. In some embodiments the exhaust valve 132 may be positioned in the exhaust bypass conduit 130. When the flow of exhaust gas 122 is directed through the exhaust bypass conduit 130, it may travel directly to the environment, or it may reconnect with the with the exhaust conduit 128 such that the exhaust bypass conduit is in fluid communication with the exhaust conduit downstream of the compressor 118.

However, when the flow of exhaust gas 122 is directed through the exhaust conduit 128, it is directed through the compressor 118. The compressor 118, as mentioned above, is caused to rotate by the turbine 116. In one embodiment the compressor 118 is coupled to the turbine 116 by a shaft 134, such that when the turbine 116 rotates, the flow of exhaust gas 122 is compressed by the compressor. In particular, the compressor 118 is configured such that the compressor compresses the flow of exhaust gas 122 away from the internal combustion engine 102. Thus, the backpressure on the exhaust side of the internal combustion engine 102, which may inherently exist due to flow losses, and in some embodiments further caused by restrictions in the exhaust flow path such as the catalytic converter 126 and/or a muffler 136, may be reduced by the compressor 118. For example, the compressor 118 may reduce the pressure at the compressor's inlet below ambient pressure because the outlet of the compressor in communication with ambient conditions. Thereby, the compressor 118 may assist in directing the flow of exhaust gas 122 through the muffler 136 and to the environment and reduce pumping losses as explained below.

In some embodiments the flow of exhaust 122 in the exhaust conduit 128 may be directed through a heat exchanger 138. The heat exchanger 138 may be configured to transfer heat from the flow of exhaust gas 122 to the flow of air 104 in the air supply conduit 110. By heating the flow of air 104, the flow of air is provided with more energy which may be extracted by the turbine 116. In some embodiments the catalytic converter 126 may be upstream of the heat exchanger 138, as illustrated. This may be desirable because the catalytic converter 126 may require heat in order to function properly, and hence on startup of the internal combustion engine 102 it may be desirable to heat the catalytic converter rapidly to begin reducing emissions quickly. Accordingly, by positioning the catalytic converter 126 upstream of the heat exchanger 138, the catalytic converter may receive more heat from the flow of exhaust gas 122 than if the catalytic converter was placed downstream of the heat exchanger. Upstream and downstream, as used herein, refer to the position of a component of the engine system 100 relative to the normal flow of fluid through the component. In particular, downstream refers to placement which is generally past the referenced component in terms of the normal flow of the fluid during operation of the engine system 100. Conversely, upstream may refer to placement which is generally before the referenced component in terms of the normal flow of the fluid during operation of the engine system 100.

In some embodiments the flow of air 104 may additionally or alternatively be directed through an after-cooler 140 prior to entering the cylinders 106 of the internal combustion engine 102. The after-cooler 140 may comprise an air-to-air after-cooler in some embodiments, whereas in other embodiments the after-cooler may comprise an air-to-water after-cooler as is known within the art. However, regardless of the particular embodiment which is employed, the after-cooler 140 functions to cool the flow of air 104 before it enters the internal combustion engine 102 and thereby reduce the density and temperature of the flow of air 104. The after-cooler 140, and in some embodiments additional cooling apparatuses, may thereby be selected to achieve the desired temperature and/or desired density of the air in the intake manifold 120. Cooling of the flow of air 104 may be desirable in some embodiments because cooler air may make the air, when mixed with fuel, less likely to combust prematurely. Premature combustion, also known as knock, may potentially be damaging to the internal combustion engine 102 and reduces engine performance in terms of efficiency and power output. Further, cooling of the flow of air 104 may help to protect components on the intake side of the internal combustion engine 102 from temperatures which exceed their usable limits. Cooling of the flow of air 104 using the after-cooler 140 may thus be used to offset the heating of the flow of air by the heat exchanger 138. In this regard, the after-cooler 140 may not be necessary in all embodiments of the system 100. For example, when the system 100 does not include the heat exchanger 138, the air leaving the outlet of the turbine 116 may be below ambient temperature due to the expansion of the air as it passes through the turbine.

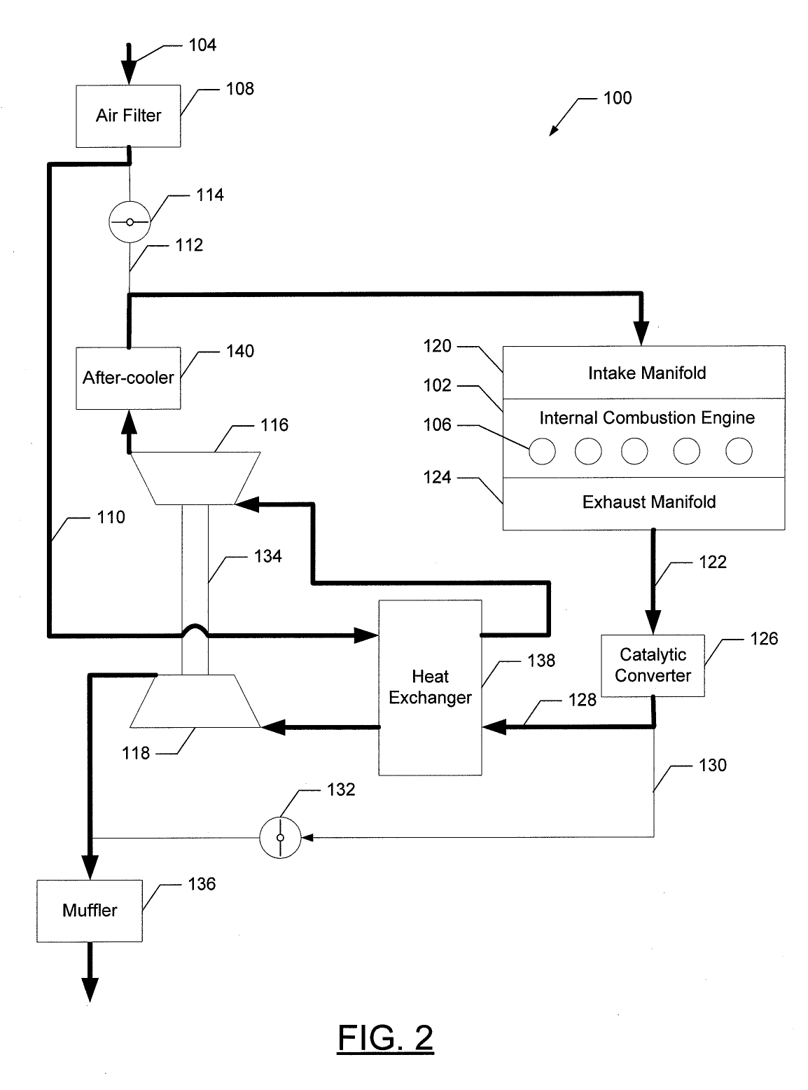

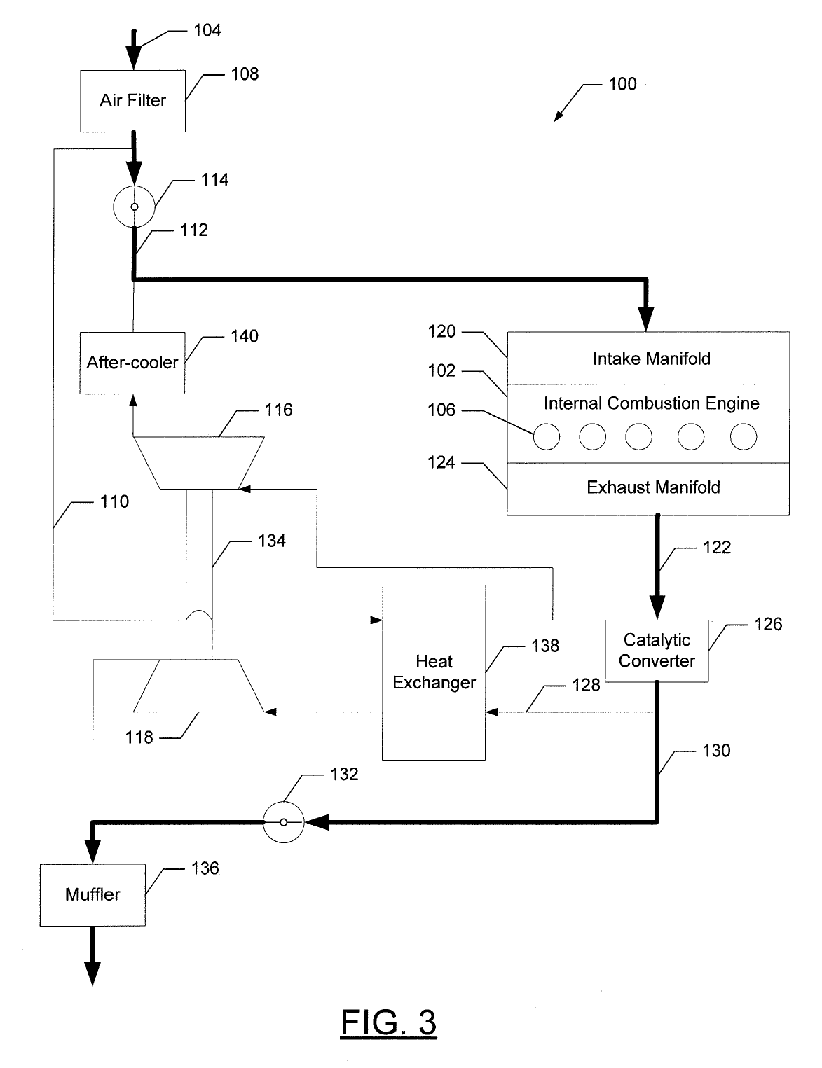

Thus, as described above, the flow of air 104 may be directed through one or both of the air supply conduit 110 and the bypass conduit 112, and the flow of exhaust gas 122 may be directed through one or both of the exhaust conduit 128 and the exhaust bypass conduit 130. In terms of the particular configurations of the valves 114, 132, which direct the flows, embodiments further provide for methods of controlling the flow of air 104 to the internal combustion engine 102. In this regard, FIG. 2 illustrates the engine system 100 when it is operating in idle or partial-throttle conditions, and FIG. 3 illustrates the engine system when it is operating in full-throttle conditions.

As illustrated in FIG. 2, when the internal combustion engine 102 is operating in idle or partial-throttle conditions, the fresh air valve 114 is configured to direct the flow of air 104 along a flow path (bolded for clarity) whereby the flow of air travels through the air supply conduit 110 to the internal combustion engine 102. As previously described, this flow path may direct the flow of air 104 through the heat exchanger 138 and the after-cooler 140 prior to entering the internal combustion engine 102 in order to increase efficiency.

With regard to the flow of exhaust gas 122, the flow path is illustrated (bolded for clarity). As illustrated, the flow of exhaust gas 122 is directed by the exhaust valve 132 through the exhaust conduit 128 and the compressor 118 therein. As the compressor 118 rotates, this may act to reduce the back pressure in the exhaust conduit 128 on the exhaust side of the internal combustion engine 102, and direct the flow of exhaust gas 122 out through the muffler 136.

By reducing the backpressure in the exhaust conduit 128, and more generally backpressure on the exhaust side of the internal combustion engine 102, the efficiency of the internal combustion engine may be increased. In particular, the efficiency of the internal combustion engine 102 may be increased by reducing the pumping losses associated with pushing the flow of exhaust gas 122 through the exhaust conduit 128 and other exhaust-side components. Further, the compressor 118, which reduces the backpressure, is driven by the turbine 116. The turbine 116, in turn, is caused to rotate by the flow of air 104 which is supplied to the internal combustion engine 102. Thus, the turbine 116, may act to regulate the flow of air 104 to the internal combustion engine 102, and in doing so the turbine may convert the energy associated with regulating the flow of air into rotational power. Thus, energy that would otherwise be lost by directing the flow of air 104 through a restriction, such as in a traditional throttle body valve embodiment, may be recovered. In particular, when the turbine 116 is used to reduce the density of the flow of air 104 into the internal combustion engine 102 and thereby control the engine load, work is extracted from the flow of air. For the same manifold pressure in the intake manifold 120, the internal combustion engine 102 would still have to exert the same amount of additional work to overcome the pumping loss as is required in traditional throttle body applications. However, the work extracted by the turbine 116 reduces the pumping losses by lowering the pressure on the exhaust side of the internal combustion engine 102, for example in the exhaust manifold 124. Accordingly, the internal combustion engine 102 may not need to produce as much output in order to overcome the pumping losses, and accordingly higher engine efficiency may be achieved.

In some embodiments the flow of air 104 into the internal combustion engine 102 may be controlled by adjusting the flow of air through the turbine 116. In particular, in some embodiments the system 100 may comprise a variable nozzle, and thus the flow of air 104 may be controlled by adjusting the variable nozzle and thereby adjusting the flow of air to the turbine 116. Further, as illustrated, in some embodiments the fresh air valve 114 is the only valve for controlling flow of air 104 into the intake manifold 120. Accordingly, the load of the internal combustion engine 102 may be controlled in a substantially simple manner. Further, by using just one valve, the air intake assembly may occupy a relatively small amount of space which may be important when the engine system 100 is employed in an automotive context. Also, the fresh air valve 114 may be used to adjust the flow of air 104 between the air supply conduit 110 and the bypass conduit 112 to control the flow of air to the internal combustion engine 102, to thereby obtain the desired airflow in conjunction with the turbine 116. Accordingly, for example, stoichiometric combustion, or other desired air-to-fuel combustion ratios may be achieved.

Although the flow of air 104 through the engine system 100 may be controlled by directing the flow of air through the turbine 118 in the air supply conduit 110, in some instances a greater flow of air to the internal combustion engine 102 may be desired. Thus, in such instances, rather than directing the entirety of the flow of air 104 through the air supply conduit 110, the fresh air valve 114 may direct some, or all, of the flow of air through the bypass conduit 112. For example, FIG. 3 illustrates the engine system 100 when it directs all of the flow of air 104 through the bypass conduit 112. Thus, FIG. 3 illustrates the engine system 100 when it is operating in full-throttle conditions, wherein maximum output from the internal combustion engine 102 is desired.

As illustrated, the flow path of the flow of air 104 (bolded for clarity) is directed through the bypass conduit 112 by the fresh air valve 114. Accordingly, the flow of air 104 bypasses the turbine 116 in the air supply conduit 110, which would present a restriction to the flow of air. Thus, the flow of air 104 may travel to the internal combustion engine 102 substantially unimpeded.

With regard to the flow of exhaust gas 122, it travels along a flow path (bolded for clarity) through the exhaust bypass conduit 130 due to the exhaust valve 132 being open. Thus, the flow of exhaust gas 122 bypasses the exhaust conduit 128 and the compressor 118. Bypassing the compressor 118 may be desirable under full-throttle conditions because the compressor 118 may act as a restriction to the flow of exhaust gas 122 when it is not being rotated by the turbine 116. Since the flow of air 104 is not directed through the turbine 116 (or is directed in smaller quantities) during full-throttle conditions, the compressor 118 may not be rotating (or may not be rotating rapidly enough to reduce backpressure), such that the exhaust bypass conduit 130 is a less restrictive flow path for the flow of exhaust gas 122. Accordingly, under full-throttle conditions the flow of exhaust gas 122 may bypass the compressor 118 and travel through the muffler 136 to the environment.

Thus, methods of controlling the flow of air 104 to the internal combustion engine 102 are provided. In one embodiment a method comprises selectively directing the flow of air 104 to the internal combustion engine 102 with the fresh air valve 114 through the air supply conduit 110 with the turbine 116 therein, and the bypass conduit 112 configured to bypass the turbine. The method further comprises expanding the flow of air 104 through the turbine 116 to generate shaft power using vacuum created by the internal combustion engine 102. Additionally, the method comprises driving the compressor 118 connected to the exhaust side of the internal combustion engine 102 using the shaft power from the turbine 116 to thereby receive and compress the flow of exhaust gas 122. Thus, the compressor operates to reduce backpressure on the exhaust side of the internal combustion engine 102.

The method may further comprise heating the flow of air 104 in the air supply conduit 110 by directing the flow of air through the heat exchanger 138 which is configured to transfer heat from the flow of exhaust gas 122 to the flow of air. The method may additionally comprise cooling the flow of air 104 before the flow of air enters the internal combustion engine 102 by directing the flow air through the after-cooler 140. The after-cooler 140 may be placed downstream of the turbine 116, such that the flow of air 104 is cooled by the after-cooler after the flow of air is expanded by the turbine.

In some embodiments the method may further comprise directing the flow of exhaust gas 122 through the exhaust bypass conduit 130 to thereby bypass the compressor 118 when the flow of air 104 is directed by the fresh air valve 114 through the bypass conduit 112. Additionally or alternatively, the method may further comprise adjusting a nozzle of the turbine 116 to control the flow of air 104 in to the internal combustion engine 102. Accordingly, methods for controlling the flow of air 104 into the internal combustion engine 102 are provided.

Many modifications and other embodiments will come to mind to one skilled in the art to which these embodiments pertain having the benefit of the teachings presented in the foregoing descriptions and the associated drawings. Therefore, it is to be understood that modifications and other embodiments are intended to be included within the scope of the appended claims. Although specific terms are employed herein, they are used in a generic and descriptive sense only and not for purposes of limitation.

That which is claimed:

1. An engine system comprising:
an internal combustion engine comprising one or more cylinders;
an air intake assembly configured to supply a flow of air to the one or more cylinders of the internal combustion engine, the intake assembly comprising:
an air supply conduit with a turbine therein;
a bypass conduit configured to bypass the turbine; and
a fresh air valve configured to selectively direct the flow of air to one or both of the air supply conduit and the bypass conduit;
an exhaust conduit configured to receive a flow of exhaust gas from the one or more cylinders of the internal combustion engine and direct the flow of exhaust gas away from the internal combustion engine; and
a compressor in the exhaust conduit configured to reduce backpressure in the exhaust conduit.

2. The system of claim 1, further comprising an intake manifold configured to receive the flow of air from the intake assembly and distribute the flow of air to two or more of the cylinders.

3. The system of claim 2, wherein the fresh air valve is the only valve for controlling the flow of air into the intake manifold.

4. The system of claim 1, further comprising an exhaust manifold configured to receive the flow of exhaust gas from one or more of the cylinders of the internal combustion engine and direct the flow of exhaust gas to the exhaust conduit.

5. The system of claim 1, further comprising a heat exchanger configured to transfer heat from the flow of exhaust gas in the exhaust conduit to the flow of air in the air supply conduit.

6. The system of claim 1, further comprising a catalytic converter upstream of the heat exchanger.

7. The system of claim 1, further comprising an after-cooler configured to cool the flow of air before the flow of air enters the internal combustion engine.

8. The system of claim 7, wherein the after-cooler is configured to cool the flow of air after the flow of air is expanded by the turbine.

9. The system of claim 1, further comprising an exhaust bypass conduit and an exhaust valve, wherein the exhaust valve is configured to selectively direct the flow of exhaust gas from the one or more cylinders of the internal combustion engine to the exhaust conduit and the exhaust bypass conduit.

10. The system of claim 9, wherein the exhaust valve is in the exhaust bypass conduit.

11. The system of claim 9, wherein the exhaust bypass conduit is in fluid communication with the exhaust conduit downstream of the compressor.

12. The system of claim 1, wherein the fresh air valve is in the bypass conduit.

13. The system of claim 1, further comprising a variable nozzle.

14. A method of controlling a flow of air to an internal combustion engine, comprising:
selectively directing the flow of air to the internal combustion engine with a fresh air valve through an air supply conduit with a turbine therein, and a bypass conduit configured to bypass the turbine;
expanding the flow of air through the turbine to generate shaft power using vacuum created by the internal combustion engine; and
driving a compressor connected to an exhaust side of the internal combustion engine using the shaft power from the turbine to thereby receive and compress a flow of exhaust gas,
wherein the compressor operates to reduce backpressure on the exhaust side of the internal combustion engine.

15. The method of claim 14, further comprising heating the flow of air in the air supply conduit by directing the flow of air through a heat exchanger configured to transfer heat from the flow of exhaust gas to the flow of air.

16. The method of claim 14, further comprising cooling the flow of air before the flow of air enters the internal combustion engine by directing the flow of air through an after-cooler.

17. The method of claim 16, wherein the flow of air is cooled by the after-cooler after the flow of air is expanded by the turbine.

18. The method of claim 14, further comprising directing the flow of exhaust gas through an exhaust bypass conduit to thereby bypass the compressor when the flow of air is directed by the fresh air valve through the bypass conduit.

19. The method of claim 14, further comprising adjusting a nozzle of the turbine to control the flow of air into the internal combustion engine.

20. An air intake assembly configured to supply a flow of air to the one or more cylinders of an internal combustion engine, the intake assembly comprising:
an air supply conduit with a turbine therein;
a bypass conduit configured to bypass the air supply conduit; and
a fresh air valve configured to selectively direct the flow of air to one or both of the air supply conduit and the bypass conduit.
